(19) United States
(12) Patent Application Publication
(10) Pub. No.: US 2003/0002639 A1
(43) Pub. Date: Jan. 2, 2003

(54) Real-time call validation system

(76) Inventor: David L. Huie, Merritt Island, FL (US)

Correspondence Address: MCKENNA LONG & ALDRIDGE LLP, 1900 K STREET, NW, WASHINGTON, DC, 20006, US

(21) Appl. No.: 09/895,171

(22) Filed: Jul. 2, 2001

(51) Int. Cl. G06F 17/60; H04M 15/00

(52) U.S. Cl. 379/114.27; 705/14; 455/406

(57) ABSTRACT

Telecommunication carriers that provide collect and bill-to-third-party calls face considerable revenue losses due to unbillable, uncollectible, and fraudulent calls. This real-time call validation system reduces the number of unbillable calls by determining when the dialed number has been ported, the originating carrier has no billing relationship with the terminating carrier, or the dialed number belongs to a customer of a switchless reseller, all events that in today's environment would result in an unbillable call. This system also decreases subscriber fraud by identifying in real-time a dialed number's listed name and address and determining whether there are other numbers associated with said name and address and, if so, whether they are associated with a history of fraud, bad debt, or unbillability. Finally, this system provides a real-time method for applying industry-standard credit assessment tools to the management of collect and bill-to-third-party accounts.

### BACKGROUND OF THE INVENTION

1. Field of the Invention

The present invention relates in general to telecommunications systems and in particular to methods for reducing bad debt, fraud and unbillability related to collect and, in some cases, bill-to-third-party telephone calls utilizing a real-time call validation system.

2. Discussion of the Related Art

Collect and Bill-to-Third-Party Call Billability

Telecommunications carriers typically invoice collect calls to the called party through a called party's Local Exchange Carrier (LEC) with a call detail record (CDR) of the call appearing on the called party's local telephone bill. Today, as many as ten percent of collect calls are deemed “unbillable;” that is, the carrier that provides the collect call service is unable to invoice the called party for the call through their LEC. If a collect or “bill-to-third-party” call is unbillable, the originating carrier must find a way to bill the called party (or the “bill-to-party” in the case of a bill-to-third-party call) directly. Not only is this process costly, but typically carriers only end up collecting 5% to 10% of the revenues for collect and bill-to-third-party calls that they bill directly.

There are three primary reasons why so many collect calls are unbillable: the introduction of Local Number Portability (LNP), the growth in the number of Competitive Local Exchange Carriers (CLECs), and the development of switchless resellers.

Local Number Portability is a telecommunications network capability that allows a subscriber of a telecommunications service provider (a user) connected to the public switched telephone network (PSTN) through a particular service provider to move to a different service provider while retaining his or her public directory number. Such change of service provider will at some time likely result in the user's telephone appearance on the network moving to a different switching system. In moving to a different service provider, the user becomes a “ported subscriber.” Other network users can connect to the ported subscriber without any changes to their dialing procedures.

Telephone numbers in the pre-LNP environment are assigned to local telephone end offices on the basis of geography. Numbers begin with a three digit numbering plan area designation, or NPA (more commonly known as an area code), followed by an office exchange number or NXX (i.e., the first three digits of a local seven digit telephone number). A complete telephone number takes the form of an NPA-NXX office designation and a four-digit line number sequence, or NPA-NXX-XXXX. Each XXXX represents one of 10,000 different customer telephone numbers. In effect, the dialed NPA-NXX is the terminating switch's (pre-LNP) routing address for the rest of the network. Thus a pre-LNP telephone number serves two functions: identifying the customer, and providing the network with information needed to route a call to the customer. Upon introduction of LNP, these two functions are separated.

A basic approach that has been adopted for implementing LNP is known as location routing number (LRN) architecture. The LRN architecture uses a unique 10-digit location routing number to identify each switch in the network for call-routing purposes. As in the familiar 800/888 (or, more generally, 8xx) toll-free calling service, an LNP database is used to store routing information, but the LNP database stores routing information for telephone numbers of subscribers who have selected another local service provider and have been moved to that provider's switching system. Thus, the LNP database contains the directory numbers of all ported subscribers and the location routing number, or LRN, of the switch now serving each of these numbers. LNP requires that end-office switching systems be able to determine whether a dialed NPA-NXX is included in the portability environment. In making this determination, switching systems typically set triggers to occur based on detection of a dialed number including an NPA-NXX for which portability is available. Usually, only one customer's line need be ported for the trigger to be active for all XXXX associated with that NPA-NXX.

These triggers are designed to give rise to a query to the Local Number Portability database (“LNP database”) to retrieve the Local Routing Number of the dialed number. The LNP database is typically accessed for such queries from switches using advanced intelligent network (AIN 0.1) telecommunications call processing capabilities and signaling protocols such as transaction control application part (TCAP) intelligent network protocols. That is, queries from switches to an LNP database, and responses from the LNP database, are advantageously communicated using standard common channel signaling messages over the CCS7 (Common Channel Signaling System 7) network.

Typically, the switch (a Service Switching Point or SSP) from which the call originates sends an LNP query over the signaling network to a Signal Control Point (SCP) which accesses the LNP database in order to retrieve the routing information for a ported subscriber. If the dialed number has been ported, the query response from the SCP will contain the pertinent Local Routing Number in the Called Party Number (CPN) field and the Ported Dialed Number (PDN) (i.e., the number originally dialed) in the Generic Address Parameter (GAP) field. Alternatively, if the call is destined to a number that has not been ported, the query response will simply keep the dialed NPA-NXX-XXXX number (the dialed number or DN) in the CPN parameter to indicate that it should be used for routing purposes.

Carriers will provide LNP via a system of multiple, regional databases. Such regional databases reduce capacity concerns that would be encountered with a single national LNP database and reduce the distance over which routing information need be sent. These regional databases are administered and maintained by a national Number Portability Administration Center (NPAC). NPAC provides updates to these databases when end users change terminating office connections, typically when these users are moved from one local service provider's switching system to another local service provider's switching system.

The introduction of Local Number Portability has created new challenges for communications carriers that need to bill for collect calls and calls billable to third parties. Carriers typically do not bill the recipients of a collect call directly for that call. Rather, they provide the call detail record (CDR) to the recipient's local exchange carrier (LEC) to be billed on the call recipient's local telephone bill. To accomplish this task, carriers often use a billing clearinghouse to bill their collect calls, although they may also elect to perform this function themselves.

In most cases, the carrier will, on a weekly basis, send a data file to the clearinghouse containing the call detail records (CDR) for all of its collect calls for the previous week. The clearinghouse will import the CDR file into its billing program which will then analyze the NPA-NXX of each CDR to determine to which other telecommunications carrier the CDR should be sent in order to bill the call on the recipient's local phone bill. To determine which NPA-NXX belongs to which carrier, the clearinghouse relies on NPA-NXX database tables provided and maintained on a national basis by the Traffic Routing Administration (TRA), a division of Telcordia Technologies (formerly Bellcore). For example, analysis of the CDR of a collect call to 404-467-XXXX would determine that the CDR should be sent to BellSouth to be rebilled to the call recipient on his or her local phone bill.

In a pre-LNP environment, the method of analyzing the NPA-NXX to determine to which carrier to CDR should be sent functioned satisfactorily. The nationwide implementation of LNP, however, has resulted in a significant increase in the number of collect calls that telecommunications carriers are unable to rebill through the LECs. If subscribers port their directory numbers to a different carrier, in essence, they have changed their local exchange carrier without changing their NPA-NXX. Upon analysis of the NPA-NXX of the CDR of a call to such a subscriber, the clearinghouse will mistakenly send the CDR to the carrier to which the TRA assigned that NPA-NXX. However, as the subscriber has ported the directory number to a different carrier, the carrier to which that NPA-NXX belongs will reject the CDR and send it back to the clearinghouse with a Return Code of 50.

A Return Code 50 indicates that the call cannot be billed by the receiving carrier due to non-ownership, portability or resale of the line. Non-ownership simply means that the NPA-NXX of the CDR did not belong to the carrier to which the CDR was sent in the first place. Portability, as has been described above, implies that while the NPA-NXX of the dialed number does belong to the carrier to which the CDR was sent, the number has been ported to a different carrier. Resale means that the number belongs to a customer buying local exchange services from a non-facilities based (i.e., switchless) reseller of the local exchange carrier's service. In such a case, the carrier will actually terminate the collect call on behalf of the reseller, but the CDR will be rejected with a Return Code 50 because the CDR should be sent to the reseller rather than to the local exchange carrier.

U.S. Pat. No. 5,699,416 to Atkins (1997) attempts to address some of these issues by querying a LNP database to identify the appropriate Line Identification Database (LIDB) for performing billing validation. LIDB databases typically contain all billable directory number accounts maintained by a service provider. Carriers query LIDB databases prior to connecting a collect, third party, or calling card call to validate the dialed number (e.g., can it receive collect calls), the calling card (e.g., is the PIN correct), etc. As more CLECs enter the local telecommunications market, they may choose to maintain their own LIDB database or choose to use a LIDB database shared with other service providers. Thus dialed directory numbers with the same NPA-NXX may be found in different LIDB databases.

Atkins provides a way of determining which of a plurality of LIDB databases a carrier should query to validate a call. However, a dialed number may be ported to a different carrier yet still be contained in the same LIDB database in which it was originally stored. In fact, given that there are currently only twelve LIDB databases in North America covering extensive regional areas, this is more likely to be the case than not. In such a case, a clearinghouse would still be unable to bill the collect call to the correct local exchange carrier. The billing clearinghouse, which still parses call detail records on the six-digit NPA-NXX rather than the ten-digit dialed number, will provide the CDR to the LEC to which the NPA-NXX has been assigned. The LEC will still reject the call detail record since the dialed number has been ported to another carrier. In other words, identifying the correct LIDB database to query does not ensure that the call can still be billed correctly. Atkins' invention fails to provide a way of identifying when a number has been ported and block a call to that number prior to its connection.

It is therefore one object of the present invention to reduce the number of unbillable collect and bill-to-third-party calls that result when the call recipient has ported his or her directory number to a different local service provider.

The proliferation of new competitive local exchange carriers (CLECs), both facilities-based (have their own switches) and non-facilities based, has also driven a significant increase in the number of unbillable collect calls. To rebill a call to another carrier, the originating carrier or its billing service provider must have a contractual agreement in place with the carrier providing the called party's local service in order to rebill the call. In some instances, the clearinghouse may actually not have a direct billing relationship with the recipient's carrier, particularly in the event the carrier is one of the smaller CLECs. In such cases, the clearinghouse may have a billing relationship with another clearinghouse that specializes in billing to the increasingly large number of smaller CLECs. Illuminet and NECA are two such clearinghouses that specialize in rebilling calls to smaller CLECs. Thus a call to a subscriber of such a CLEC may go from the originating carrier to its clearinghouse to a second clearinghouse before eventually being rebilled through the CLEC to the call recipient. However, in an ever increasing number of cases, the originating carrier or its clearinghouse will not have either a direct or an indirect (i.e., through a second clearinghouse) billing relationship with the call recipient's carrier. In such a case, a collect call to such a carrier would be unbillable. The dilemma for the originating carrier of a collect is to know prior to connecting the call whether it has a billing relationship—direct or indirect—established with the carrier that will ultimately be responsible for invoicing the called or billed party for the call.

It is therefore an object of the invention to reduce the number of unbillable collect and bill-to-third-party calls by identifying when the call recipient or billed party is a subscriber of a local service provider with which the originating carrier has no direct or indirect billing relationship.

The third major source of unbillable collect and bill-to-third-party calls is a result of the development largely since the Telecommunications Act of 1996 of the switchless or non-facilities based reseller. A switchless reseller is a company that, as the name implies, resells the services of a local exchange carrier under its own brand name. Since the reseller is “switchless” (or “non-facilities based”), the LEC must provide the necessary switching services to the reseller's customers. The reseller typically provides sales, marketing, billing, and collection services which are branded under the reseller's corporate name.

At the end of a billing period, the LEC will provide billing information to the reseller in order to invoice the reseller's customers. The reseller can then provide its customers an invoice under its own letterhead. Alternatively, the LEC may produce invoices for the reseller utilizing the reseller's letterhead.

When a collect or bill-to-third-party call is placed to a number of a customer of a switchless reseller, the originating carrier will go through the same routine as it does with any other collect or bill-to-third-party call. Typically this consists of first performing a LIDB query to determine whether or not the dialed number is allowed to receive a collect call. If the query response is affirmative, the carrier will then query an LNP database to determine whether the number has been ported, and, if so, to where the call should be routed. Having determined that the dialed number can receive a collect call (i.e., no blocking indicator has been set in the LIDB database) and that the number has not been ported, the carrier will connect the call to the dialed number.

A dilemma arises when the originating carrier (or its billing clearinghouse) needs to bill the called party, the reseller's customer, for this call. The originating carrier will analyze the NPA-NXX of the dialed number and determine that the call detail record should be sent to the LEC in question. However, the LEC will reject the call detail record with a Return Code of 50, because the pertinent call detail record should be sent to the switchless reseller. In all likelihood, the originating carrier will have no billing relationship, either direct or indirect, with the switchless reseller as switchless resellers are many in number, are usually quite small in size, and typically have billing relationships only with the LEC providing their switching service. Hence, collect and bill-to-third-party calls to switchless resellers are almost always unbillable.

The Ordering and Billing Forum of the Alliance for Telecommunications Industry Solutions (ATIS) has been discussing the issue of billing collect and bill-to-third-party calls to the customers of switchless resellers for a considerable time. However, at the time of writing, the telecommunications industry has yet to come up with a solution to this problem.

This problem manifests itself with particular acuity in the inmate telephone business. Realizing that collect calls to switchless resellers may go unbilled, the families and friends of inmates may even subscribe to a switchless reseller's service specifically to receive inmate collect calls. One analysis of a sample of collect calls from inmates in correctional facilities indicated that as many as five percent of the calls were made to customers of switchless resellers all of which were therefore unbillable.

It is therefore an object of the invention to reduce the number of unbillable collect and bill-to-third-party calls by querying a multiplicity of databases to determine whether the dialed number belongs to a switchless reseller.

It is a further object of the invention to reduce the number of unbillable collect and bill-to-third-party calls by querying a database of collect call records to determine if previous calls to a particular number were unbillable.

Subscriber Fraud

Fraudulent telephone activity for collect and bill-to-third-party calls presents a significant and increasing problem to telecommunications carriers. Such fraudulent activity may include subscriber fraud. Typically, this type of fraudulent activity occurs when a subscriber signs up for telecommunications services and proceeds to use the services with no intent to ever pay for the services provided. Such a fraudulent subscriber would continue to use the services without paying until the network access was blocked by the service provider.

This category of subscriber fraud is quite prevalent in the inmate calling business, the segment of the telecommunications industry dedicated to providing phone services to jail and prison inmates. Inmates' family members will obtain a second telephone number from a different local exchange carrier from the one providing their primary service. The family members will use that second number to receive collect calls from the inmates, incurring substantial telephone charges which they never pay. When the LEC providing the second line finally disconnects the service (often after a period of many months during which a significant amount of collect call debt has been incurred), the inmates' family may simply obtain a third telephone number from yet another LEC, and the fraud begins all over again.

Prior attempts to detect and prevent such fraudulent telephone calls have been made, but with generally unsatisfactory results. For instance, because the LEC's are responsible for billing most customers utilizing the long distance or interexchange carrier's (IXC) toll services, the LEC would provide customers who were delinquent in paying their bills with a predetermined grace period prior to suspending the delinquent customer's access to the IXC network for collect and third party service. As a result, the IXC would continue to incur high revenue losses as a result of the delinquent customer's continued use of long distance services during this grace period until access to such service was suspended by the LEC.

U.S. Pat. No. 5,754,632 to Smith (1998) attempts to address subscriber fraud partially by utilizing address information to determine if one customer account matches another. However, this patent does not provide a solution to subscriber fraud in relation to collect or bill-to-third-party calls. For example, the proposed solution depends on the analysis of address data that are part of the account information owned by a particular telecommunications carrier. By their very nature, collect and bill-to-third-party calls are more often than not to telephone numbers (i.e., accounts) that do not belong to the originating carrier. Hence U.S. Pat. No. 5,754,632 fails to provide a solution to subscriber fraud when no address data are available because the called party is not a subscriber of the originating carrier's service.

It is therefore one object of the invention to provide a method of identifying the described type of subscriber fraud prior to the connection of a collect or bill-to-third-party call to a called party that is not necessarily a customer of the originating carrier. What is needed is a real-time method for obtaining the address of the dialed number and determining whether that same address has been used for other dialed numbers, and, further, whether a history of fraud, bad debt, and/or delinquent accounts is associated with that same address.

The lack of a listed name and address prior to the processing of a collect call presents one other problem in the inmate calling business. Typically, in prisons or penitentiaries, inmates' phone calls are restricted to a list of numbers that is commonly known as an “allow list.” For example, an inmate may only be allowed to call his mother, his girlfriend, and his attorney. If the inmate attempts to call a number that is not on his/her allow list, the inmate telephone system blocks the call.

Currently, correctional officers have no automated way of verifying that the telephone numbers on the lists submitted by the inmates belong to the people the inmates claim they do. The verification of the numbers on inmates' allows lists is so labor-intensive that the ownership of most numbers simply goes unverified. In other words, correctional staff simply must trust that the inmate is providing accurate information as to who are the owners of the telephone numbers on his/her allow list, which, for obvious reasons, is far from an ideal situation. It is therefore an additional object of the invention to provide an automated method of verifying ownership of the telephone numbers on a correctional inmate's allow list.

Finally, it common within the inmate calling industry to analyze the calls made by multiple inmates to a common telephone number. The purpose of such analysis is to detect possible patterns of illicit activity (e.g., drug trafficking) that may be perpetrated from within a single or multiple correctional facilities. One obvious way that inmates can evade such security efforts is to call multiple numbers that connect to the same address.

What is needed is a real-time method for providing a listed name and address for each telephone number an inmate dials. It is therefore one object of the present invention to provide such a method.

Utilizing Credit Scores to Assess Risk and Reduce Bad Debt

Telecommunications carriers use a variety of tools to minimize bad debt. Included among these is the use of credit scores provided by credit reporting bureaus to establish and update subscribers' credit limits. Those skilled in the art are well familiar with how credit scores are used to minimize the risk of bad debt in providing services to a carrier's own subscribers.

In the case of a collect call, the originating carrier must rebill the call to the called party, which, in most cases, is not a subscriber of the carrier's own service. The carrier has no means of obtaining a credit score or performing a credit assessment of the called party as it does not know in advance to whom its subscriber (i.e., the calling party) will make a collect call. Furthermore, the originating carrier does not have the data (name, address, telephone number, and, ideally, Social Security number) typically required to obtain credit information related to the called party. In essence, the originating carrier is extending credit to the called party blindly with no ability to assess the latter's ability or willingness (based on past payment history) to pay for charges incurred.

This dilemma manifests itself with particular acuity in the inmate calling business, that segment of the telecommunications industry dedicated to providing telephone services to inmates in correctional facilities. Whereas collect calls make up only a small percentage of the gross revenues of most telecommunications carriers, an overwhelming percentage of inmate calling providers' revenues is derived from collect calls. The rate of bad debt or “uncollectibles” in the inmate calling industry averages between 10% and 15% of gross revenues, a staggering percentage in comparison with other segments of the telecommunications industry or, indeed, any industry. As described above, inmate calling providers have no method for using credit information such as credit scores to set credit limits and/or determine whether a collect call should even be connected given the respective credit history of the called party.

Some inmate calling providers do set credit limits on the monetary value of collect calls that can be made to a particular number during a particular period (e.g., $200 per month). However, since no credit information (e.g., a credit score) is available prior to the call being connected, such credit limits tend to be set on a “one size fits all” basis. In other words, every call recipient's credit limit is set at the same level regardless of whether they have a good credit history or a bad one.

U.S. Pat. No. 5,615,408 to Johnson, et al. (1997) provides a means of using credit scores for managing accounts of subscribers of telecommunications services. However, this patent fails to provide the real-time solution required by providers of collect call and bill-to-third-party call services. The patent describes a method that requires that a carrier wishing to use credit information for account management purposes have in hand the data necessary for obtaining the desired credit information related to the a specific account or phone number (typically the subscriber's name, address, and Social Security number). Such a solution is inadequate for providers of collect call and bill-to-third-party call services as they typically only have one piece of data—the dialed telephone number—and nothing more.

What is needed is the ability to obtain a credit score and/or perform a credit assessment of the called party or third party prior to the connection of a collect or bill-to-third-party call. It is therefore one object of this invention to provide a real-time method for enabling telecommunications carriers to obtain credit scores and perform credit assessments of the called party in real-time to make credit decisions based on the called party's (or bill-to-third-party's) credit history and thereby reduce the bad debt and fraud associated with collect and bill-to-third-party calls.

### SUMMARY OF THE INVENTION

Accordingly, the present invention is directed to a real-time call validation system that substantially obviates one or more of the problems due to the limitations and disadvantages of the related art.

The present invention is a call validation system that provides a range of services designed to reduce the amount of unbillable, uncollectible, and fraudulent collect and, in some cases, bill-to-third-party calls. To reduce the number of unbillable collect calls, the invention utilizes a series of queries of Local Number Portability databases and other databases containing NPA-NXXs and Operating Company Numbers (OCNs) to (1) determine whether there is a previous history associated with that number of bad debt, fraud, or unbillability, (2) determine whether the dialed number has been ported, (3) identify the local service provider that will terminate the call, (4) determine whether the originating carrier has a billing relationship with said local service provider, and (5) determine whether the dialed number belongs to the customer of a switchless reseller.

To reduce subscription fraud, the invention performs a reverse directory lookup of in a directory assistance database to obtain the dialed number's listed name and address, then searches a database to determine if there are other dialed numbers associated with that same address, and, if so, whether those numbers involve bad debt or delinquent accounts. The invention may also be used to verify in a correctional facility whether the telephone numbers submitted by an inmate indeed belong to the person to whom the inmate claims. The invention may also further be used to detect when calls from one or more correctional facilities have been made to the same address by multiple inmates.

Finally, to decrease bad debt, the invention uses the telephone number, listed name and address and other data provided by the carrier (e.g., Social Security number) to obtain a telco credit score and other credit information that can be used to determine whether credit should be extended in the form of a collect or bill-to-third-party call, and, if so, how much.

Accordingly, several objects and advantages of the present invention are that it provides a real-time method for accomplishing the following tasks:

It is an object of the present invention to provide a real-time call validation method that reduces the percentage of unbillable collect and bill-to-third-party calls by determining whether the dialed telephone number is associated with a previous history of unbillability, bad debt, or fraud.

It is an object of the present invention to provide a real-time call validation method that reduces the percentage of unbillable collect and bill-to-third-party calls further by determining whether the dialed telephone number has been ported prior to the connection of the call.

It is an object of the present invention to provide a real-time call validation method that reduces the percentage of unbillable collect and bill-to-third-party calls further by determining prior to the connection of the call whether originating carrier has a direct or indirect billing relationship with the terminating carrier.

It is an object of the present invention to provide a real-time call validation method that reduces the percentage of unbillable collect and bill-to-third-party calls further by determining prior to the connection of the call whether the dialed number belongs to a switchless reseller.

It is an object of the present invention to provide a real-time call validation method that decreases subscriber fraud by determining if there are other telephone numbers associated with the dialed number's listed address that involve bad debt or delinquent accounts.

It is an object of the present invention to provide a real-time call validation method that facilitates the ability of staff in correctional facilities to verify ownership of a telephone number submitted by an inmate for his/her allow list.

It is an object of the present invention to provide a real-time call validation method that enhances the capability of correctional officers to determine when multiple inmates have made telephone calls to the same address.

It is an object of the present invention to provide a real-time call validation method that minimizes the carrier's risk and reduces bad debt by providing the ability to use credit scores and other credit information to determine whether to connect a collect call, and, if so, set how much credit extend to the called party.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a simplified block diagram of a portion of a telecommunications network, including signaling network components, suitable for determining call billability, preventing subscriber fraud, and utilizing credit information to manage collect call accounts in accordance with the present invention.

FIG. 2 is an illustrative diagram showing the steps performed in accordance with a preferred embodiment of the present invention for determining call billability.

FIG. 3 is an illustrative diagram showing the steps performed in accordance with the preferred embodiment of the present invention's method of determining whether a collect call is to the customer of a switchless reseller.

FIG. 4 is an illustrative diagram showing the steps performed in accordance with a preferred embodiment of the present invention of preventing subscriber fraud.

FIG. 5 is an illustrative diagram showing the steps performed in accordance with a preferred embodiment of the present invention for utilizing a reverse directory lookup to obtain a telephone number's listed name and address to verify ownership of said telephone number.

FIG. 6 is an illustrative diagram showing the steps performed in accordance with the preferred embodiment of the present invention for utilizing a reverse directory lookup to obtain a telephone number's listed name and address to determine whether multiple inmates have made calls to the same address.

FIG. 7 is an illustrative diagram showing the steps performed in accordance with the preferred embodiment of the present invention for utilizing credit information to manage collect call and bill-to-third-party accounts.

FIG. 8 is an illustrative diagram showing the steps performed in accordance with an alternative embodiment of the present invention for utilizing credit information to manage collect call and bill to third party accounts.

### DETAILED DESCRIPTION OF THE PREFERRED EMBODIMENTS

Reference will now be made to the preferred embodiments of the present invention, examples of which are illustrated in the accompanying drawings.

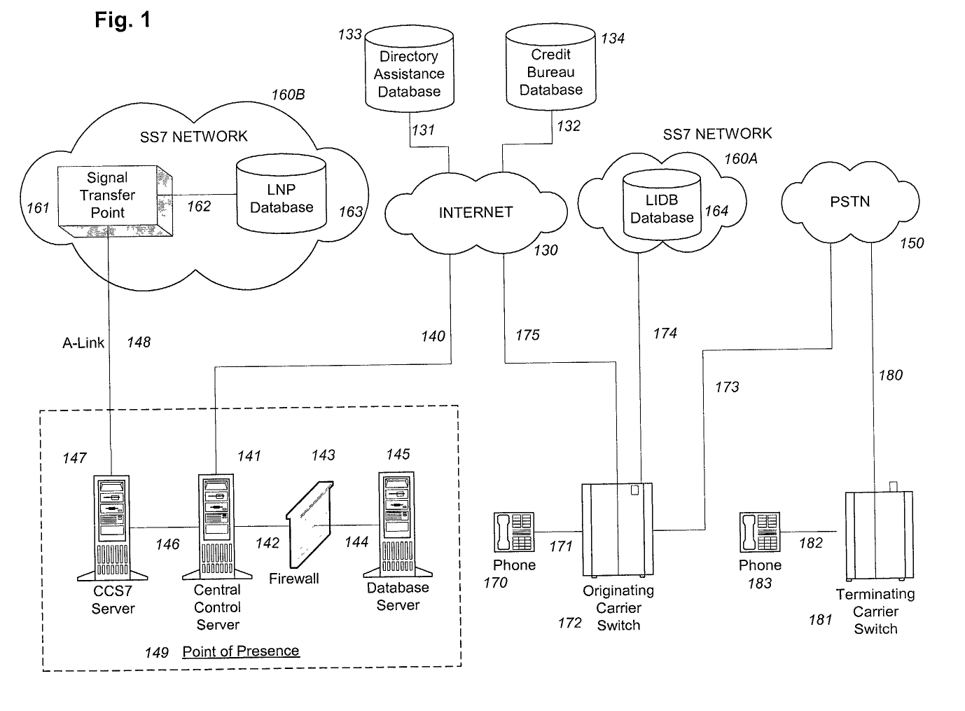

In a preferred embodiment, the present call validation system consists of a combined computer and telecommunications system as illustrated in FIG. 1. Exemplary operation of the preferred embodiment will now be described. In this example, telephone 170 is connected via circuit 171 with the originating carrier's switch 172, which, in all likelihood, would be the switch of a Local Exchange Carrier (LEC). Switch 172 is connected via circuit 173 to the Public Switched Telephone Network (PSTN) 150. The calling party at telephone 170 wishes to make a collect call to telephone 183. Telephone 183 is connected via circuit 182 to the terminating carrier's switch 181 which, in all likelihood, is also a Local Exchange Carrier's switch. Switch 181 is connected to the PSTN 150 via circuit 180. Typically, when switch 172 wishes to send a collect call to a number not resident in its own database, it will perform a query on a Line Identification Database 164 available via circuit 174 that connects the switch 172 to the SS7 network 160A. The purpose of this query is to determine whether the dialed number is capable of receiving a collect call.

The Point of Presence 149 (POP) is a telecommunications facility housing various hardware and software systems required to offer the real-time call validation services. To send call validation queries to POP 149, originating switch 172 is connected to the Internet 130 via circuit 175. POP 149 is in turn connected to the Internet 130 via circuit 140. The POP contains four principal elements. The first is a Central Control Server 141 that receives and processes validation queries from customers of the validation service (i.e., telecommunications carriers). Central Control Server 141 is connected to a Database Server 145 via circuits 142 and 144 with a firewall 143 in between to provide data security.

Central Control Server 141 is also connected via circuit 146 to SS7 Server 147. SS7 Server 147 contains special boards such as those manufactured by NMS Communications that enable queries and responses to be sent to and from the SS7 Network. SS7 Server 147 is connected to the SS7 Network 160B via a 64 kbps circuit 148 known as an “A-Link.” Server 147 connects with a Signal Transfer Point (STP) 161, which relays queries over circuit 162 to Local Number Portability Database 163.

To perform its real-time validation services, Central Control Server 141 must also be capable of querying other databases available via the Internet 130. In particular, Central Control Server 141 will send queries to a Directory Assistance Database 133 connected to the Internet via circuit 131. Similarly, the Central Control Server 141 will send queries to a Credit Reporting Bureau Database 134 connected to the Internet via circuit 132.

One skilled in the art can appreciate that the principles of the invention are not limited by the architecture of the switching and/or computer network used, but rather are applicable to a wide variety of switching and computer network architectures. For example, all of the call validation services provided by this invention could be performed utilizing telecommunications and computer equipment housed within the same facility as the originating carrier switch. Similarly, said call validation services could even be embedded within the software of the originating switch itself or in a peripheral computer connected to the originating switch. For the sake of simplicity, a single telecommunications and computer network architecture has been described above for the purposes of illustrating the operation of the present invention.

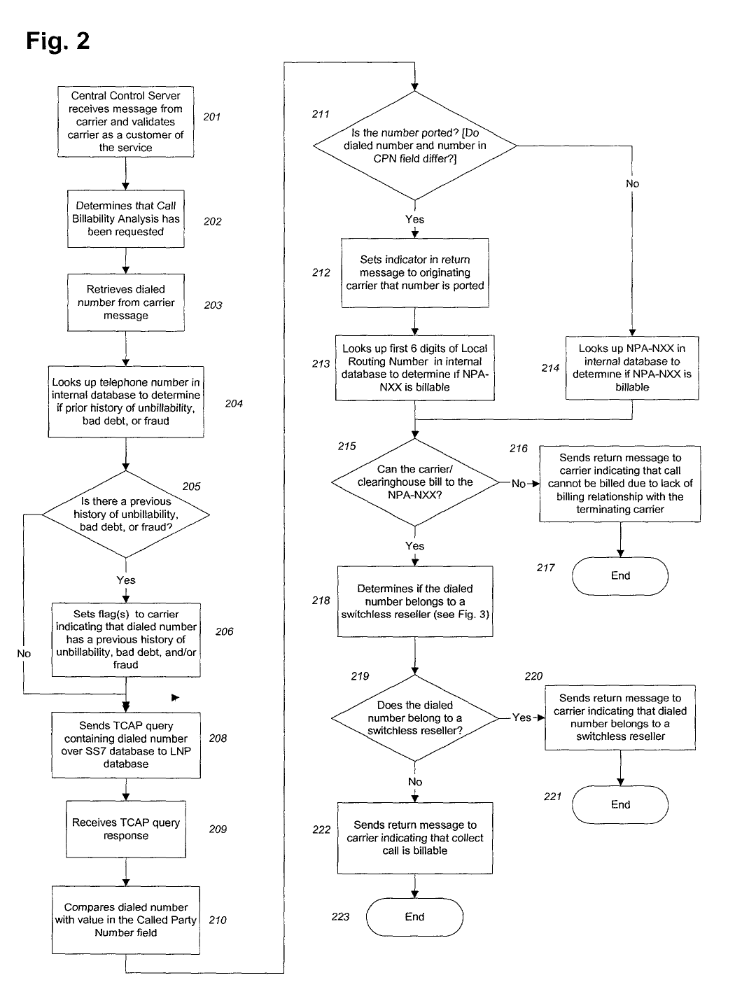

FIG. 2 illustrates how the invention will determine whether a collect call or bill-to-third-party calls is billable. Description is made with reference to FIGS. 1 and 2. Prior to connecting a collect call from phone 170 to phone 183, originating carrier switch 172 (or some peripheral computer equipment connected to switch 172) will send a message over the Internet 130 (or alternatively over a direct circuit) to Central Control Server 141 for the purpose of determining whether the call will be billable. This message will contain, among other data, the dialed number (i.e., phone 183's directory number) to which the calling party wishes to make the collect call. In Step 201, the Central Control Server 141 receives this message, authenticates the message, and validates the carrier as a customer of the call validation service. In Step 202, Central Control Server 141 determines that the carrier has requested that the billability of the dialed number be analyzed. In Step 203, Central Control Server 141 retrieves the dialed number from the carrier's message. In Step 204, Central Control Server 141 looks up the dialed number in an internal database stored on Database Server 145 to determine if the number is associated with a prior history of unbillability, bad debt, or fraud (see decision point 205). If there is such a history, the Central Control Server 141 will set the relevant flags in Step 206 in the response message to be sent back to the originating carrier.

The next series of steps relate to determining whether the dialed number has been ported or not. In Step 208, Central Control Server 141 sends a message to SS7 Server 147 containing the pertinent telephone number. In Step 208, SS7 Server 147 sends a TCAP query to LNP Database 163 via the SS7 Network 160. SS7 Server 147 receives the query response in Step 209 and passes this information back to Central Control Server 141. In Step 210, Central Control Server 141 compares the ten digits in the Called Party Number field (field 15) of the query response with the original dialed number to determine if the number has been ported (that is, moved to the switch of a carrier to which the NPA-NXX of the dialed number does not belong).

Step 211 represents the decision point where the invention determines whether the number has been ported. If the number has been ported, the Called Party Number (CPN) field in the query response message will contain the Local Routing Number rather than the dialed directory number, and the dialed directory number will have been placed in the Generic Address Parameter field (field 80). If not ported, the dialed directory number will be the same as the number in the Called Party Number (CPN) field contained in the query response message.

If the query response indicates a ported number, in Step 212 Central Control Server 141 will set an indicator to be used in the return message to the originating carrier that the number has been ported, and, as such, may need to be blocked. The term “blocked” or “block” as used herein is not intended to be limited simply to the denial of a call. Instead, the term may be user-defined to include, for example, denial of the call, redirecting the call to a live operator, offering the caller or the called party an alternative billing method, and so forth. In one alternative embodiment of the invention, the carrier may insert an indicator or flag in the Call Detail Record to indicate to the carrier's own billing program or that of its clearinghouse that the call needs to be invoiced to a carrier different from the carrier to which the dialed number's NPA-NXX belongs.

The purpose of Steps 213 or 214 is to identify who the terminating carrier is. If the dialed number has been ported, in Step 213 Central Control Server 141 will extract the first six digits of the Local Routing Number which, in essence, equate to an NPANXX belonging to the terminating switch. To identify the terminating carrier, Central Control Server 141 will then look up these six digits in an internal database stored on Database Server 145 that contains tables of NPA-NXXs and the carriers to which they belong. Such tables are available on a subscription basis from the Traffic Routing Administration, a division of Telcordia Technologies. If the dialed number has not been ported, in Step 214 Central Control Server 141 will simply use the NPA-NXX of the dialed number to perform this lookup query. Central Control Server 141 will use these queries to obtain both the carrier's name and the Operating Company Number (OCN) of the terminating carrier.

Having identified the terminating carrier, the next Step 211 is to determine whether the originating carrier has a billing relationship (either direct or indirect) with the terminating carrier. Once again, the Central Control Server 141 will look up in tables in an internal database on Database Server 145 to determine whether the originating carrier can bill calls to the terminating carrier. The originating carrier or its clearinghouse may provide the tables containing the OCNs of carriers with which they have billing agreements. Alternatively, Central Control Server 141 may examine a table of NPANXXs to which the originating carrier or clearinghouse has indicated it can bill calls.

Step 215 represents the decision point where it is determined whether the carrier or the clearinghouse can bill to the pertinent NPA-NXX. If not, in Step 216, Central Control Server 141 returns a message to the carrier indicating that the call cannot be billed due to the lack of a billing relationship with the terminating carrier.

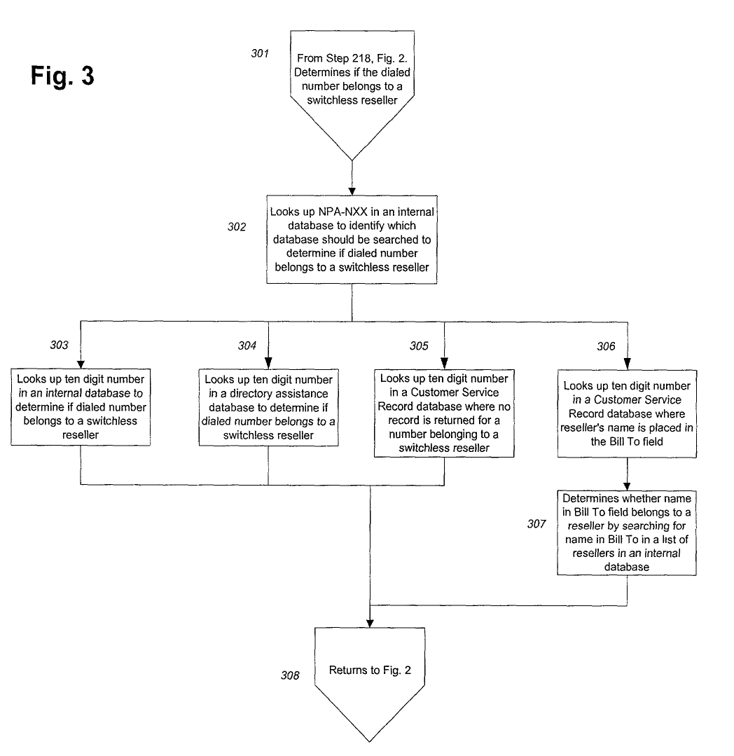

If determined that the carrier or clearinghouse can bill to the pertinent NPA-NXX, Central Control Server 141 proceeds to Step 218 where it determines if the dialed number belongs to a switchless reseller. FIG. 3 contains an exploded view of how the present invention determines whether the number belongs to a switchless reseller. The first Step (302) is to look up the NPA-NXX of the dialed number in an internal database to identify which database should be searched to determine whether a number with a particular NPA-NXX belongs to a switchless reseller.

There are four options. First, in Step 303, Central Control Server 141 searches an internal database where the Local Exchange Carrier has agreed to provide a database of reseller numbers. Second, in Step 304, Central Control Server 141 performs a query in Directory Assistance Database 133 where the LEC in question consistently identifies when a listed number belongs to a switchless reseller.

The other remaining two options involve queries of LEC's proprietary databases (referred to herein as “Customer Service Record databases”) that are used by CLECs and IXCs to make inquiries about particular numbers, order repair work, etc. In Step 306, Central Control Server 141 queries the type of Customer Service Record database where if the number belongs to a switchless reseller, the database query returns no record. In Step 306, Central Control Server 141 queries the type of Customer Service Record database where the reseller's name is stored in the Bill To field. In an additional step (307), Central Control Server 141 determines through a query of an internal database of reseller names whether the name in the Bill To field is a switchless reseller.

Returning to FIG. 2, if it is determined the dialed number belongs to a customer of switchless reseller, in Step 220 Central Control Server 141 returns a message to the originating carrier indicating as such. Alternatively, having determined that the dialed number has not been ported nor belongs to the customer of a switchless reseller and that that the originating carrier has a billing relationship with the terminating carrier, Central Control Server 141 will in Step 222 return a message indicating that the call appears to be billable.

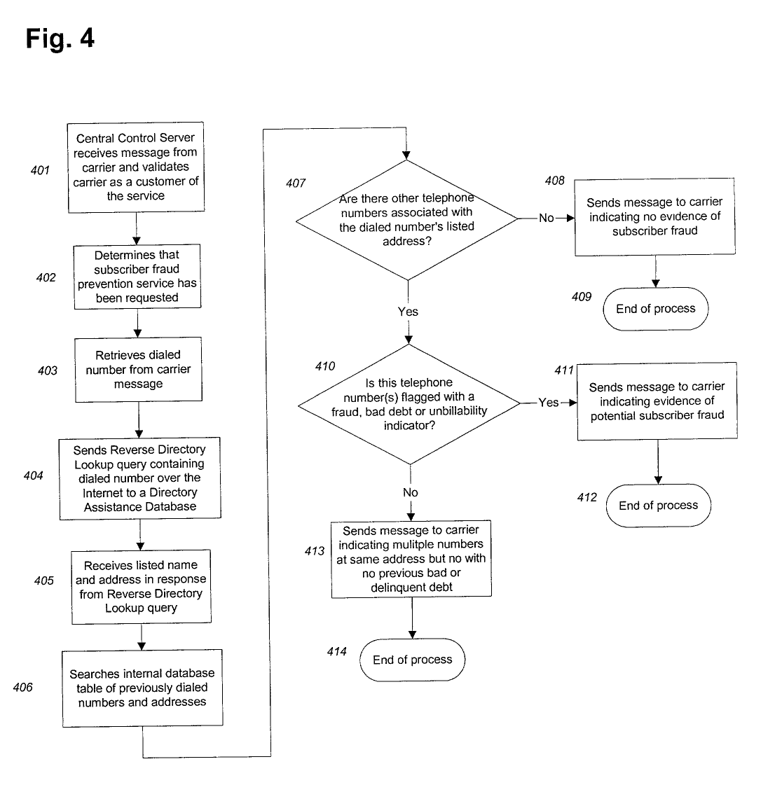

FIG. 4 describes the Steps involved in the present invention's real-time method for preventing subscriber fraud. In a typical scenario, the calling party will attempt to make a collect call to a particular number. The originating carrier wishes to determine whether there is any evidence of subscriber fraud associated with the dialed number. In Step 401, Central Control Server 141 receives a message from said carrier and validates the carrier as a customer of the subscriber fraud prevention service. In Step 402, Central Control Server 141 determines that the carrier has requested the subscriber fraud prevention service.

Central Control Server 141 retrieves the dialed number from the carrier's message in Step 403, and in Step 404 sends a Reverse Directory Lookup query containing this number to Directory Assistance Database 133. In Step 405, Central Control Server 141 receives the query response containing the listed name and address then searches an internal database stored in Database Server 145 in Step 406 to determine if there are other telephone numbers associated with the dialed number's listed name and address (decision point 407).

If not, Central Control Server 141 returns a response in Step 408 to the carrier indicating that there is no evidence of subscriber fraud. However, if another telephone number(s) has been found that is associated with the dialed number's listed name and address, the same query is used to determine whether there is any previous history of fraud, bad debt, or unbillability associated with the other telephone number(s) (decision point 410). If so, in Step 411 Central Control Server 141 returns a message to the carrier indicating what evidence was found. If no such evidence is found, in Step 413 Central Control Server 141 returns a message indicating the existence of other number(s) associated with the same listed name and address as the dialed number but with no previous history of fraud, bad debt or unbillability. While not shown on FIG. 4 for simplicity's sake, the message returned to the carrier may indicate when there is a match on the listed address but not the listed name and when there is a match on both fields.

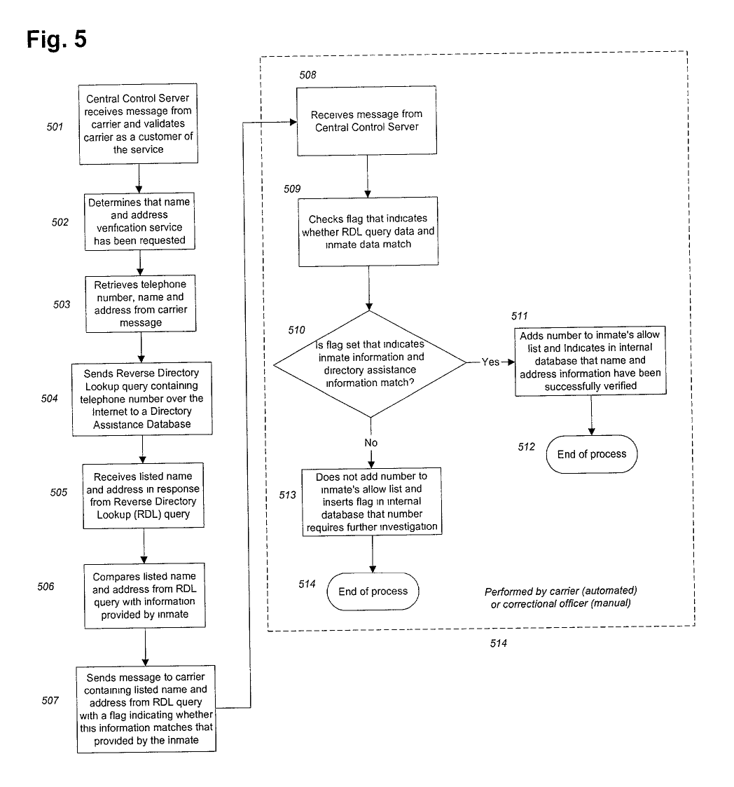

FIG. 5 depicts an alternative embodiment of the present invention, namely an automated method for verifying the ownership of a telephone number. As described in the Background section above, one application of this embodiment could involve a correctional officer who wishes to verify the information related to a list of telephone numbers provided to him/her by a prison inmate. However, many other potential applications exist. For example, a hospital emergency room admissions clerk may wish to verify the information that a patient (or a family member) has provided on a registration sheet.

As in FIG. 4, Steps 501 through 505 in FIG. 5 describe how the present invention will obtain in real-time the listed name and address of a particular telephone number utilizing a Reverse Directory Lookup (RDL) query of Directory Assistance Database 133. However, in this scenario, the carrier sends not only the telephone number(s) in question but the supposed owner's name and address as provided by the inmate. In Step 506, Central Control Server 141 compares the actual listed name and address provided from the RDL query with the information provided by the inmate. In Step 507, a response message is sent to the carrier containing the listed name and address information from the RDL query along with a flag that is set to “true” to indicate that these data match those provided by the inmate and to “false” if they do not.

Typically, all the Steps contained in dotted box 514 would be performed either on an automated basis by the carrier's inmate telephone system or manually by a correctional officer. In Step 508, the message containing the listed name and address is received from Central Control Server 141. The flag indicator is checked in Step 509 to determine if the RDL query data and the inmate data match (refer to decision point 510). If the flag is set to “true,” then in Step 511, the telephone number is added to the inmate's list of numbers he/she is allowed to dial and another flag is set to indicate that the name and address information have been successfully verified. If the information from the RDL query and the inmate's list do not match, then in Step 513 a flag is set to indicate that further investigation is required.

One skilled in the art can appreciate that an equally possible alternative would be for the carrier (or the corrections facility itself) to send a message containing only the telephone number that the inmate wishes to add to his/her allow list. Upon performing the RDL query, Central Control Server 141 would return the listed name and address, and the carrier or the correctional staff would themselves compare the data returned in the RDL query with that provided by the inmate.

As noted in the Background section above, most inmate telephone systems provide a report that indicates when multiple inmates have called the same telephone number. The purpose of the report is to help correctional staff and police investigators identify potential patterns of illicit activity (e.g., drug trafficking). Currently, inmates may thwart such efforts by dialing multiple numbers at the same address.

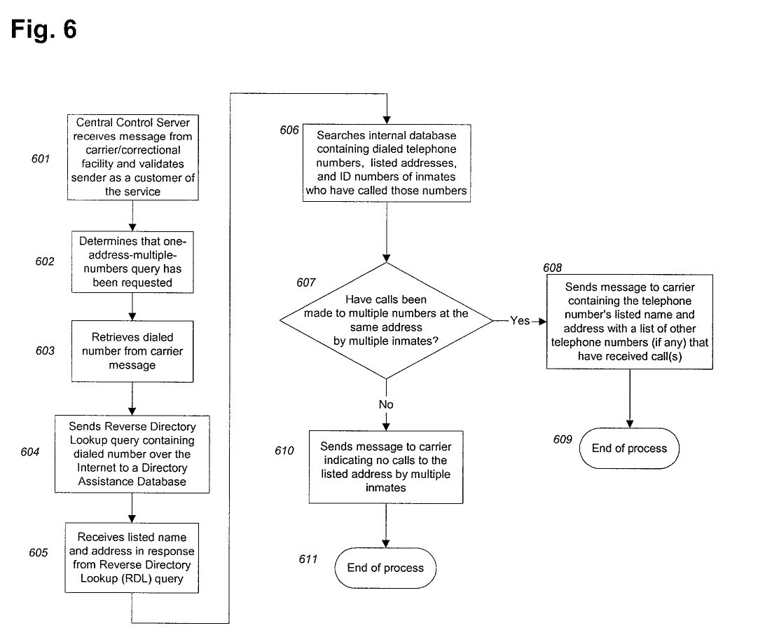

FIG. 6 describes yet another alternative embodiment of the invention, in this case, a method of determining when multiple inmates of correctional facilities have called telephone numbers at the same address. As before, Step 601 show how Central Control Server 141 receives a message from the originating carrier or correctional facility and validates the carrier or facility as a customer of the service. In Step 602 it is determined that the one-address-multiple-numbers query has been requested. In Step 603 Central Control Server 141 retrieves the dialed number from the message and, in Step 604, performs a Reverse Directory Lookup query in Directory Assistance Database 133

Upon receipt of the RDL query response in Step 605, Central Control Server 141 in step 606 searches an internal database stored on Database Server 145 for other telephone numbers with the same listed address as that provided in the message from the carrier or correctional facility. If no address information were readily available in such a database, Central Control Server 141 could alternatively obtain from the Directory Assistance Database 133 other telephone numbers listed with the number from the original query and then query an internal database to determine if these numbers had been previously called by an inmate. As a third alternative, Central Control Server 141 could simply obtain all the telephone numbers with a given listed address and return those to the carrier or correctional facility so that they could determine whether calls had been made to these numbers on their own.

Step 407 shows the decision point of whether calls have been made to the same address (either to one number of multiple numbers) by multiple inmates. If yes, Central Control Server 141 sends a response to the carrier or correctional facility containing a list of the telephone numbers called as well as the listed name and address. If no, Central Control Server 141 responds that no other inmates have called the particular address in question.

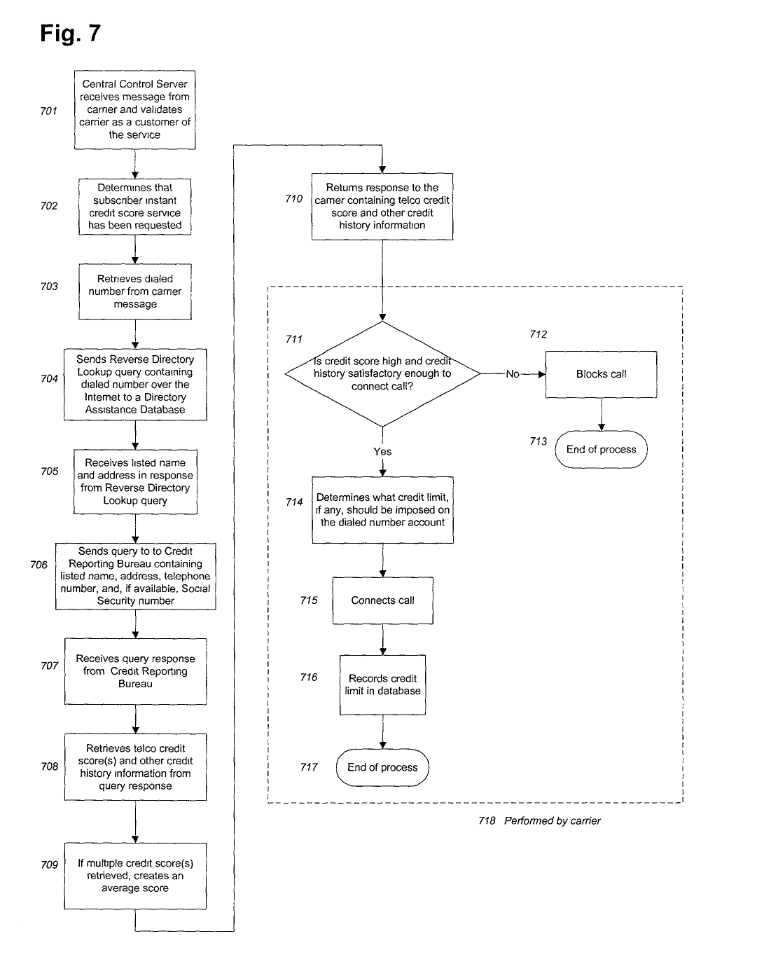

FIG. 7 describes the Steps involved one embodiment of the present invention's real-time method for providing credit scores and other credit information to providers of collect and bill-to-third-party call services. As before, in step 701 Central Control Server 141 receives a message from the carrier that is originating the call and validates the carrier as a customer of the service. In Step 702, Central Control Server 141 determines that the instant credit score service has been requested and, in Step 703, retrieves that dialed number from the carrier's message. Step 704 consists of Central Control Server 141 sending a Reverse Directory Lookup query in Directory Assistance Database 133, the response to which is received in Step 705.

In Step 706, Central Control Server 141 utilizes the dialed number and the information provided by the Reverse Directory Lookup query (listed name and address) to send a second query to Credit Reporting Bureau database 134, the response to which is received in Step 707. Central Control Server 141 in Step 708 then retrieves the credit score and other credit history information obtained from Credit Reporting Bureau database 134. Typically this credit score will be a “telco credit score” especially developed for the telecommunications industry for trying to predict the likelihood that a consumer will or will not pay his/her telephone bill. The other credit information provided may include, for example, records of any unpaid telephone or other utility bills over the last 24 months. In some cases, multiple scores may be returned (e.g., two instances of a “B. Smith” residing at “123 Main Street”). In such cases, Central Control Server 141 in Step 709 creates an average credit score. In Step 710, Central Control Server 141 returns the credit score(s) and other credit information to the originating carrier.

Armed with this credit information, the carrier must now decide whether to connect the call or not (decision point 711). If the credit score is very low or the called party shows a history of not paying his/her telephone bill, the carrier may decide to block the call (Step 712). The term “blocked” or “block” as used herein is not intended to be limited simply to the denial of a call. Instead, the term may be user-defined to include, for example, denial of the call, redirecting the call to a live operator, offering the caller or the called party an alternative billing method, and so forth.

Should the carrier elect to connect the call (Step 715), it may still use this credit information, as depicted in Step 714, to determine what credit limit, if any, should be imposed on the dialed number account. For example, the carrier may decide to set a limit of $150 per month on collect and bill-to-third-party calls to the dialed number in question. Or, alternatively, the credit score and history may be so favorable that the carrier decides not to set any credit limit on calls that number. The key point is that the carrier now has relevant information provided in real-time that enables it to make credit decisions (e.g., connect the call, establish a credit limit, etc.) on the basis of the called party's credit score and history. In Step 716, Central Control Server 141 stores the credit limit in an internal database for future use.

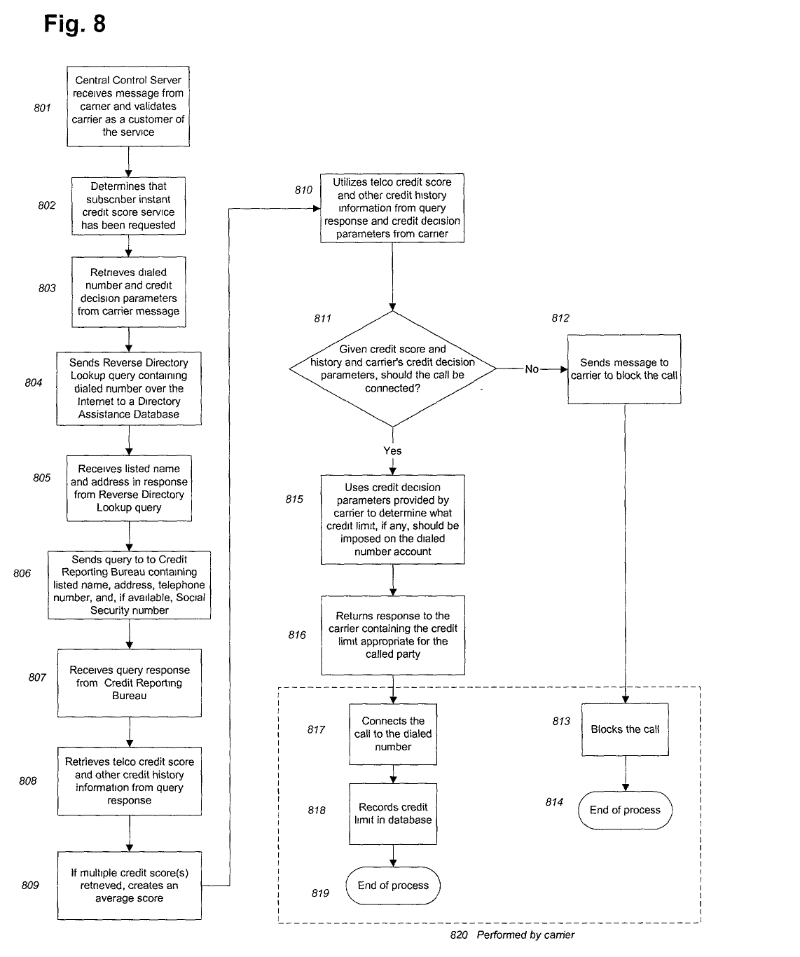

FIG. 8 describes the logic and sequence of steps of an alternative embodiment of the instant credit score service. Steps 801 through 809 are similar to Steps 701 through 709 in FIG. 7 except in Step 803, Central Control Server 41 retrieves not only the dialed number but credit decision parameters provided by the originating carrier. In Step 810, Central Control Server 41 utilizes the credit score and history in the context of the credit decision parameters provided by the originating carrier to determine whether the call should be connected or not. If not, Central Control Server 41 sends a message to the originating carrier in Step 811 to block the call which the carrier does in Step 812.

If it is decided that the call should be connected, Central Control Server 41 in Step 815 again makes use of the credit score and history and carrier's credit decision parameters to determine whether a credit limit should be established for the dialed number account and, if so, how much. In Step 816, Central Control Server 41 sends a response to the carrier indicating that the call should be connected and the credit limit to be imposed on this particular account. The carrier connects the call to the dialed number in Step 817 and records the credit limit to be established in an internal database in Step 818.

Accordingly, the reader will see that this real-time call validation system resolves at once many issues that have long plagued the providers of collect and bill-to-third-party call services. The invention significantly reduces the number of unbillable collect and bill-to-third-party calls by determining prior to the call: (1) whether the originating carrier has a billing relationship with the terminating carrier; (2) whether dialed number has been ported and therefore, in today's environment, is considered unbillable; and (3) whether the dialed number belongs to a customer of a switchless reseller which would also make such a call unbillable.

This call validation system also provides an automated method of preventing subscriber fraud by identifying the listed name and address of the dialed number in real-time and determining whether there are other telephone numbers associated with said name and address, and, if so, whether they are associated with a history of fraud, bad debt, or unbillability. The invention further provides staff in correctional facilities with an automated method for verifying ownership of numbers on inmates' proposed allow lists and enables them to identify instances where multiple inmates are calling the same address.

Finally, the present invention for the first time offers carriers a method for utilizing industry-standard credit assessment tools in determining whether a collect or bill-to-third-party call should be connected, and if so, whether a credit limit should be established and at what level.

The collective effect of the various services provided through this real-time call validation system will be to reduce carriers' losses due to unbillable, uncollectible, and fraudulent collect and bill-to-third-party calls thereby increasing their overall profitability.

What is claimed is:

1. A method of processing a telephone call prior to connecting the telephone call, comprising:
querying a database containing information about ported telephone numbers prior to connecting the telephone call; and
determining whether the telephone call is directed to a telephone number that has been ported.

2. The method of claim 1, further comprising blocking the telephone call if it is determined that the telephone number has been ported.

3. The method of claim 2, wherein the blocking step comprises preventing the call from being connected to the telephone number.

4. The method of claim 2, wherein the blocking step redirecting the telephone call to an operator.

5. The method of claim 2, wherein the blocking step comprises establishing a billing method for the telephone call.

6. The method of claim 1, wherein the telephone call is a collect call.

7. The method of claim 6, wherein the collect call is blocked.

8. The method of claim 1, wherein the telephone call is a bill-to-third-party call.

9. The method of claim 8, wherein the bill-to-third-party call is blocked.

10. The method of claim 1, further comprising providing an indicator in a call detail record associated with the telephone call if it is determined that the telephone number has been ported.

11. A method for determining billability of a telephone call, comprising:
querying a database identifying information relating to area codes and office exchange numbers prior to connection of the telephone call; and
determining from the information whether an originating carrier originating the telephone call has a billing relationship with a terminating carrier terminating the telephone call.

12. The method of claim 11, wherein the billing relationship is direct.

13. The method of claim 11, wherein the billing relationship is indirect.

14. The method of claim 11, wherein the telephone call is a collect call.

15. The method of claim 11, wherein the telephone call is a bill-to-third-party call.

16. The method of claim 11, further comprising blocking the telephone call if it is determined that the originating carrier does not have a billing relationship with the terminating carrier.

17. The method of claim 16, wherein the blocking step comprises preventing the call from being connected to the telephone number.

18. The method of claim 16, wherein the blocking step redirecting the telephone call to an operator.

19. The method of claim 16, wherein the blocking step comprises establishing a billing method for the telephone call.

20. The method of claim 11, further comprising providing an indicator in a call detail record associated with the telephone call if it is determined that the originating carrier does not have a billing relationship with the terminating carrier.

21. A method for detecting subscriber fraud related to a collect telephone call associated with a dialed telephone number, comprising:
performing a reverse directory lookup query in a database;
identifying dialed telephone number listing information associated with the dialed telephone number;
comparing the dialed telephone number listing information to listing information including associated telephone numbers to identify other telephone numbers associated with the dialed telephone number listing information; and
querying a payment information database using the other telephone numbers to determine if any of the other telephone numbers are associated with a past history of at least one of bad debt, unbillability, and fraud.

22. The method of claim 21, further comprising initiating fraud prevention activity.

23. The method of claim 22, wherein the fraud prevention activity includes blocking the collect call.

24. The method of claim 23, wherein the blocking step comprises preventing the collect call from being connected to the dialed telephone number.

25. The method of claim 23, wherein the blocking step comprises redirecting the collect call to an operator.

26. The method of claim 23, wherein the blocking step comprises establishing an alternative billing method for the collect call.

27. The method of claim 21, wherein the listing information includes a listed address.

28. The method of claim 21, wherein the listing information includes a listed name.

29. A method for detecting subscriber fraud related to a bill-to-third-party telephone call associated with a billing telephone number, comprising:
performing a reverse directory lookup query of the billing telephone number in a database;
identifying bill-to listing information associated with the billing telephone number;
comparing the bill-to listing information in said query to listing information including associated telephone numbers to identify other telephone numbers associated with the bill-to listing information; and
querying a payment information database using the other telephone numbers to determine if any of the other numbers are associated with a past history of at least one of bad debt, unbillability, and fraud.

30. The method of claim 29, further comprising initiating fraud prevention activity.

31. The method of claim 30, wherein the fraud prevention activity includes blocking the bill-to-third-party telephone call.

32. The method of claim 31, wherein the blocking step comprises preventing the bill-to-third-party telephone call from being connected.

33. The method of claim 31, wherein the blocking step comprises redirecting the bill-to-third-party telephone call to an operator.

34. The method of claim 31, wherein the blocking step comprises establishing an alternative billing method for the bill-to-third-party call.

35. The method of claim 29, wherein the bill-to listing information includes a listed address.

36. The method of claim 29, wherein the bill-to listing information includes a listed name.

37. A method of processing a telephone call, comprising:
establishing a dialed telephone number for the telephone call;
comparing the dialed telephone number to an allowed list containing allowed telephone numbers and allowed names to determine if the dialed telephone number is contained in the allowed list;
preventing the telephone call from being connected if the dialed telephone number is not contained in the allowed list;
performing a reverse directory lookup query in a database to determine a listed name associated with the dialed telephone number;
comparing the listed name to the allowed list to determine if the listed name is contained in the allowed list; and
preventing the telephone call from being connected if the listed name is not contained in the allowed list.

38. The call processing method of claim 23, wherein the allowed list also includes allowed addresses, the method further comprising:
determining a listed address associated with the dialed telephone number;
comparing the listed address to the allowed list to determine if the listed address is contained in the allowed list; and
blocking the telephone call from being connected if the listed address is not contained in the allowed list.

39. The method of claim 38, wherein the blocking step comprises preventing the telephone call from being connected to the dialed telephone number.

40. The method of claim 38, wherein the blocking step comprises redirecting the telephone call to an operator.

41. A method of providing credit information to a provider of collect call services prior to connection of a collect call associated with a dialed number, comprising:
performing a reverse directory lookup query in a directory assistance database;
identifying listing information associated with the dialed number;
querying a credit reporting database using the listing information to retrieve credit information related to the listing information; and
analyzing the credit information to determine whether the collect call should be connected.

42. A method of providing credit information to a provider of collect call services prior to connection of a collect call associated with a dialed number, comprising:
identifying listing information associated with the dialed number;
querying a credit reporting database using the listing information to retrieve credit information related to the listing information; and
analyzing the credit information to determine whether the collect call should be connected.

43. The method of claim 42, further comprising determining a credit limit associated with the collect call.

44. The method of claim 42, further comprising blocking the collect call if analysis of the credit information indicates bad credit is associated with the listing information.

45. The method of claim 44, wherein the blocking step comprises preventing the collect call from being connected to the dialed number.

46. The method of claim 44, wherein the blocking step redirecting the collect call to an operator.

47. The method of claim 44, wherein the blocking step comprises establishing an alternative billing method for the collect call.

48. The method of claim 42, wherein the credit information is used to establish a credit limit for the collect call.

49. The method of claim 42, wherein the listing information includes a listed address.

50. The method of claim 42, wherein the listing information includes a listed name.

51. The method of claim 42, wherein the credit information includes a credit score.

52. The method of claim 42, wherein the credit information includes credit history information.

53. A method of providing credit information to a provider of bill-to-third-party call services prior to connection of a bill-to-third-party call, the bill-to-third-party call associated with a bill-to telephone number, the method comprising:
performing a reverse directory lookup query in a database;
identifying listing information associated with the bill-to number;
querying a credit reporting database using the listing information to retrieve credit information related to the listing information; and
analyzing the credit information to determine whether the bill-to-third-party call should be connected.

54. The method of claim 53, further comprising determining a credit limit associated with the bill-to-third-party call.

55. The method of claim 53, wherein said credit information is used to establish a credit limit for the bill-to-third-party call.

56. The method of claim 53, further comprising blocking the bill-to-third-party call if analysis of the credit information indicates that bad credit is associated with the listing information.

57. The method of claim 56, wherein the blocking step comprises preventing the bill-to-third-party call from being connected.

58. The method of claim 56, wherein the blocking step redirecting the bill-to-third-party call to an operator.

59. The method of claim 56, wherein the blocking step comprises establishing an alternative billing method for the bill-to-third-party call.

60. The method of claim 53, wherein the credit information is used to establish a credit limit for the bill-to-third-party call.

61. The method of claim 53, wherein the listing information includes a listed address.

62. The method of claim 53, wherein the listing information includes a listed name.

63. The method of claim 53, wherein the credit information includes a credit score.

64. The method of claim 53, wherein the credit information includes credit history information

65. A method for processing a telephone call, comprising:
identifying a carrier associated with a telephone number; and
querying a database associated with the carrier, the database containing telephone numbers associated with switchless resellers, using the telephone number to determine if the telephone number is associated with a switchless reseller.

66. The method of claim 65, further comprising blocking the telephone call if the telephone number is associated with a switchless reseller.

67. The method of claim 66, wherein the blocking step comprises preventing telephone call from being connected.

68. The method of claim 66, wherein the blocking step redirecting the telephone call to an operator.

69. The method of claim 66, wherein the blocking step comprises establishing an alternative billing method for the telephone call.

70. A method of processing a telephone call, comprising:
identifying a carrier associated with a dialed telephone number;
querying a database containing telephone numbers using the dialed telephone number to determine if the carrier services the dialed telephone number; and
determining that the dialed telephone number is associated with a switchless reseller if the carrier does not service the dialed telephone number.

71. The call processing method of claim 70, further comprising blocking the telephone call if the dialed telephone number is associated with a switchless reseller.

72. The method of claim 71, wherein the blocking step comprises preventing the telephone call from being connected.

73. The method of claim 71, wherein the blocking step redirecting the telephone call to an operator.

74. The method of claim 71, wherein the blocking step comprises establishing an alternative billing method for the telephone call.

75. The call processing method of claim 70, wherein the database is a customer service database.

76. The call processing method of claim 70, wherein the customer service database is belongs to the carrier.

77. The call processing method of claim 70, wherein the database contains service records.

78. The call processing method of claim 70, wherein the database belongs to the carrier.

79. The call processing method of claim 70, wherein the database is a directory assistance database.

80. A method of processing a telephone call, comprising:
identifying a carrier associated with a dialed telephone number;
determining if the carrier services the dialed telephone number; and
determining that the dialed telephone number is associated with a switchless reseller if the carrier does not service the dialed telephone number.
